(19) United States
(12) Patent Application Publication
(10) Pub. No.: US 2025/0386836 A1
(43) Pub. Date: Dec. 25, 2025

(54) INDIVIDUAL SERVING BEEF TALLOW AND PRODUCTION METHOD THEREFOR

(71) Applicant: Kim Mehrer Vaughn, Seattle, WA (US)

(72) Inventor: Kim Mehrer Vaughn, Seattle, WA (US)

(21) Appl. No.: 18/750,944

(22) Filed: Jun. 21, 2024

(51) Int. Cl. A23D 9/04

(52) U.S. Cl. CPC A23D 9/04

(57) ABSTRACT

According to an aspect of the present invention, there is provided a method of manufacturing single servings of beef tallow, comprising: melting a bulk supply of beef tallow; pouring the melted beef tallow into a mold, wherein the mold is shaped to create single-serving size portions of beef tallow; allowing the beef tallow to harden in the mold; and removing the single-serving size portions of beef tallow from the mold. According to another aspect of the present invention, there is provided single serving of cooking fat, comprising: beef tallow, wherein the beef tallow is hardened into a solid; and wherein using the Imperial system of measurement the beef tallow is 1 tablespoon to 1 cup.

### BACKGROUND

Beef tallow comprises natural proportions of beef fat, collagen, and connective tissue while beef fat is a single component contained within beef tallow.

Production methods have been described for beef tallow in the prior art patent literature. For example, U.S. Pat. No. 11,540,530 discloses a method of producing an oil-and-fat composition, comprising the steps of: obtaining a lipase reaction product by subjecting an animal or vegetable oil and/or fat to lipase treatment; obtaining a heated reaction product by subjecting an animal or vegetable oil and/or fat to dehydration treatment by using a desiccant or an ultra high speed centrifugal separator, to a moisture content of less than 1.0% by mass and then heat treatment to 80° C. or more; and mixing the lipase reaction product and the heated reaction product, wherein the heated reaction product is optionally further subjected to peroxide removal treatment after the heat treatment. The animal or vegetable oil and/or fat is at least one selected from the group consisting of beef tallow, lard, chicken fat, mutton tallow, milk fat, olive oil, palm oil, rapeseed oil, corn oil, coconut oil, cocoa butter, coffee oil, cod oil, salmon oil, bonito oil, sardine oil, and tuna oil.

U.S. Pat. No. 8,568,813 discloses a method for separating fat from beef, comprising: combining beef provided as small pieces with a fluid comprising aqueous carbonic acid, liquid carbon dioxide and water, an aqueous alkaline solution, or an aqueous acid in a vessel; agitating the small beef pieces and the fluid in the vessel; allowing beef components comprising predominantly fat to rise to the top of the fluid and beef components comprising predominantly lean beef to settle to the bottom of the fluid; removing the beef components comprising predominantly fat from the fluid; and removing the beef components comprising predominantly lean beef from the fluid.

For many years between the 1950s and up nearly until the present, Americans demonized saturated animal fats and mistakenly blamed them for increased rates of heart disease. In 1990, McDonald's famously announced its restaurants would no longer use beef tallow to cook fries and that only vegetable oil would be used. Recently, though, it has been recognized that natural products like beef tallow are actually healthier than highly processed synthetic oils, and a trend has begun to increase the use of beef tallow versus synthetic cooking fats.

However, beef tallow is typically manufactured and sold in large bags and tubs and it is often inconvenient to use in cooking.

### SUMMARY OF INVENTION

Therefore, the present invention provides single servings of beef tallow for use in cooking.

According to an aspect of the present invention, there is provided a method of manufacturing single servings of beef tallow, comprising: melting a bulk supply of beef tallow; pouring the melted beef tallow into a mold, wherein the mold is shaped to create single-serving size portions of beef tallow; allowing the beef tallow to harden in the mold; and removing the single-serving size portions of beef tallow from the mold.

According to another aspect of the present invention, there is provided single serving of cooking fat, comprising: beef tallow, wherein the beef tallow is hardened into a solid; and wherein using the Imperial system of cooking measurements the beef tallow is portioned into units ranging from 1 tablespoon to 1 cup.

### BRIEF DESCRIPTION OF THE DRAWINGS

FIG. 1 illustrates a single serving of beef tallow and a mold therefor.

FIG. 2 illustrates a flow diagram for production of single-serving beef tallow.

### DETAILED DESCRIPTION

The patenting of single-serving beef tallow cubes represents a significant advancement in the culinary world, making it easier for home cooks to use this healthier fat alternative to vegetable oil. These pre-measured cubes come in convenient Imperial cooking measurements—ranging from 1 tablespoon to ½ cup and 1 cup—ensuring precision and simplicity in the kitchen.

Beef tallow, a natural fat cherished by our grandparents, great-grandparents and is centuries old has been unfairly overshadowed by the rise of vegetable and seed oils traditionally available only in large messy tubs or bags, these single-serving cubes promise to reintroduce this flavorful, nutrient-dense fat into modern cooking. Known for its ability to add depth and richness to dishes, beef tallow offers a nostalgic nod to traditional cooking while promoting a healthier lifestyle.

In an era where convenience is key, these pre-measured cubes eliminate the guesswork and mess associated with using beef tallow, making it an accessible option for everyone. By bringing beef tallow back into American homes in an easy-to-use format, we can revive a time-honored cooking tradition and provide a healthier alternative to processed oils. This innovation not only enhances the culinary experience but also supports a return to natural, wholesome ingredients in our daily diets.

Embodiments of the present invention will be described with reference to the attached drawings.

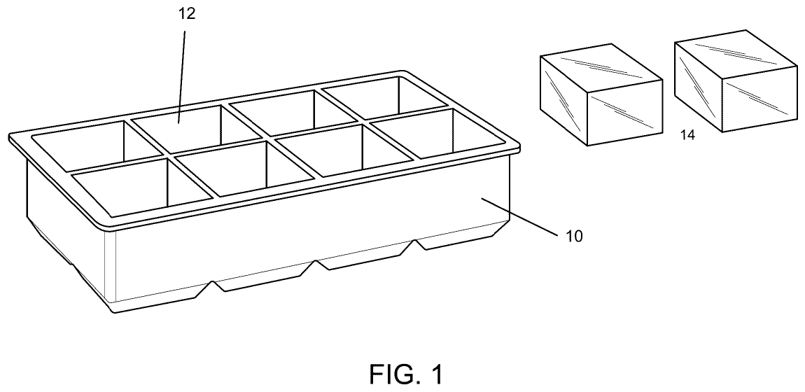

FIG. 1 illustrates a single serving of beef tallow and a mold therefor.

Mold 10 contains a plurality of slots 12 for receiving melted beef tallow. The mold can be made of silicone preferably, but plastic may be used as well. The slots 12 in the mold are sized to create individual serving size portions of beef tallow 14.

In a preferred embodiment, the individual serving size portions of beef tallow are approximately cubic in shape (but maybe other shapes as well) and range from 1 tablespoon to ½ cup and 1 cup which provides the best size for cooking a single dish in a single pan, such as a frying pan or roasting pan.

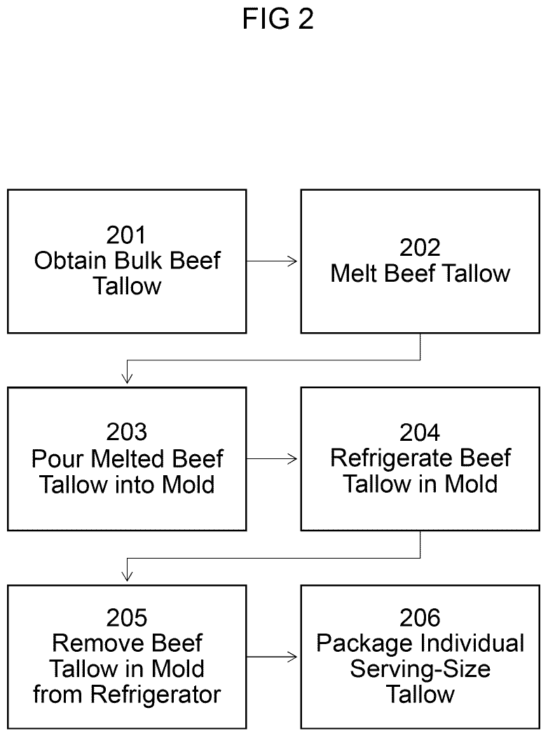

FIG. 2 illustrates a flow diagram for production of single-serving beef tallow.

Step 201 is obtaining bulk beef tallow. It is assumed the input material is beef tallow created by, for example, first grinding beef into small pieces, wherein some of the pieces will inevitably be predominantly tallow and fat and some of the pieces will be predominantly lean beef pieces. Separation of tallow in liquid takes place by settling of the higher density components that are predominantly lean beef to the bottom of the vessels and flotation of the lower density components that are predominantly tallow and fat to the surface of the liquid. Accordingly, each respective component, whether predominantly tallow and fat or lean beef, will stratify according to the density of the component and the density of the liquid. Once components are separated into strata, each respective stratum can be collected and transferred through a conduit at the top or bottom of each vessel. Then the bulk tallow can be supplied as an input to the process of the present invention.

Step 202 is melting the beef tallow. The heat can be via microwave or direct heat from an electric or gas fuel source, for example.

Beef tallow, when heat-treated to 255 degrees Fahrenheit, undergoes significant lethal treatment, effectively eliminating harmful bacteria such as Salmonella, E. coli, Campylobacter, Listeria, and Staphylococcus, among others. This process removes all moisture, rendering the beef tallow a cooked product with a shelf stability of 12-18 months without refrigeration, provided the packaging remains intact.

Key properties of beef tallow include:

Melting Point: 90 to 140 degrees Fahrenheit.

Shelf Stability: Achieved after heating to 255 degrees Fahrenheit.

Ideal Cooking Temperature: 320 to 350 degrees Fahrenheit.

Smoke Point: 410 degrees Fahrenheit.

Classification: Due to its low water activity, beef tallow is classified under “dehydrated/dried” products.

Step 203 is pouring the melted beef tallow into a mold, similar to the mold shown and described with respect to FIG. 1.

Step 204 is refrigerating the beef tallow in the mold. The beef tallow can be refrigerated at a temperature between 35 degrees and 45 degrees Fahrenheit.

Step 205 is removing the beef tallow in the mold from refrigeration and inverting the mold to release the individual single-serving size portions of beef tallow. Optimally, refrigeration should be 90 minutes in duration to obtain the highest quality product.

Step 206 is packaging individual serving-size beef tallow portions. The single-serving size portions of beef tallow are packaged in a glass jar or a plastic bag, among other packing modalities.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description. Therefore, it is intended that the disclosure not be limited to the particular embodiment(s) disclosed.

What is claimed is:

1. A method of manufacturing single servings of beef tallow, comprising:
melting a bulk supply of beef tallow;
pouring the melted beef tallow into a mold, wherein the mold is shaped to create single-serving size portions of beef tallow;
allowing the beef tallow to harden in the mold; and
removing the single-serving size portions of beef tallow from the mold.

2. The method of manufacturing single servings of beef tallow of claim 1, further comprising refrigerating the beef tallow while it is in the mold.

3. The method of manufacturing single servings of beef tallow of claim 2, wherein the beef tallow is refrigerated in the mold for approximately 90 minutes.

4. The method of manufacturing single servings of beef tallow of claim 1, wherein the mold is shaped to create cubic single-serving size portions of beef tallow.

5. The method of manufacturing single servings of beef tallow of claim 1, further comprising packaging the single-serving size portions of beef tallow.

6. The method of manufacturing single servings of beef tallow of claim 5, wherein the single-serving size portions of beef tallow are packaged in a glass jar.

7. The method of manufacturing single servings of beef tallow of claim 5, wherein the single-serving size portions of beef tallow are packaged in a plastic bag or tray.

8. The method of manufacturing single servings of beef tallow of claim 1, wherein the bulk supply of beef tallow is melted at a temperature of 255 degrees Fahrenheit.

9. The method of manufacturing single servings of beef tallow of claim 2, wherein the beef tallow is refrigerated at a temperature between 35 degrees and 45 degrees Fahrenheit.

10. A single serving of cooking fat, comprising:
Beef tallow, wherein the beef tallow is hardened into a solid; and
wherein using the Imperial system of measurement, the beef tallow is portioned into units ranging from 1 tablespoon to 1 cup.
